(19) United States
(12) Patent Application Publication
(10) Pub. No.: US 2021/0253478 A1
(43) Pub. Date: Aug. 19, 2021

(54) PROCESS FOR THE PRODUCTION OF COMPOSITE ARTICLES

(71) Applicant: NOURYON CHEMICALS INTERNATIONAL B.V., ARNHEM (NL)

(72) Inventors: Johannes Martinus Gerardus Maria REIJNDERS, Deventer (NL); Raymond Albertus Johannes TEN BROEKE, Deventer (NL)

(73) Assignee: NOURYON CHEMICALS INTERNATIONAL B.V., ARNHEM (NL)

(21) Appl. No.: 17/250,189

(22) PCT Filed: Jun. 7, 2019
(86) PCT No.: PCT/EP2019/064932

§ 371 Date: Dec. 11, 2020

(30) Foreign Application Priority Data
Jun. 12, 2018 (EP) 18177339.1

(51) Int. Cl. C04B 26/18; C04B 24/00; C04B 24/04; C04B 24/40; C04B 14/04; C04B 20/00; C04B 40/00

(52) U.S. Cl. CPC C04B 26/18; C04B 24/00; C04B 24/045; C04B 24/405; C04B 2103/10; C04B 14/04; C04B 20/0048; C04B 40/0039; C04B 24/008

(57) ABSTRACT

Process for the production composite articles, comprising the steps of:
a) providing a curable mixture comprising:
   30-95 wt % of filler material, —5-70 wt % of resin, selected from unsaturated polyester resins, vinyl ester resins, (meth)acrylate resins, and combinations thereof,
   0.5-10 phr of at least one peroxyester,
   0.1-2.0 phr of at least one organic hydroperoxide,
   the weight ratio peroxyester/organic hydroperoxide being below 14.0,
   the curable mixture being essentially free of ketone peroxide,
b) shaping the mixture, and
c) heating the shaped mixture at a temperature in the range 60-100° C. to affect hardening of the resin and the formation of an article.

### CROSS-REFERENCE TO RELATED APPLICATION

This application is a U.S. National-Stage entry under 35 U.S.C. § 371 based on International Application No. PCT/EP2019/064932, filed Jun. 7, 2019, which was published under PCT Article 21(2) and which claims priority to European Application No. 18177339.1, filed Jun. 12, 2018, which are all hereby incorporated in their entirety by reference.

### TECHNICAL FIELD

The present disclosure relates to a process for the production of filled composite articles.

Examples of such articles are agglomerated stone articles. Agglomerated stone, also called engineered stone, is a composite material in which crushed stone or rock is bound together with an unsaturated polyester resin. The most commonly used types of stone for this application are quartz and marble.

Other examples are highly filled fiber-reinforced systems, such as glass-fibre reinforced rods, angled profiles, and bridge pillars, which can be made by resin transfer moulding or pultrusion.

### BACKGROUND

Highly filled composite materials differ from other types of composite materials, such as glass-fiber reinforced polyester, in their high filler content and, consequently, their low polyester resin content. Agglomerated stone generally contains 75-95 wt % of stone or rock particles; highly filled fiber-reinforced systems generally contain 50-75 wt % of fibers.

Agglomerated stone articles are generally prepared by mixing the required ingredients—including filler (e.g. quartz, crushed stone, marble, or sand), resin, and initiator—and casting the mixture in a mould or on a temporary support, followed by curing it in an oven.

Highly filled fiber-reinforced composites are generally made by pultrusion, in which a mixture of the desired ingredients is pulled through a heated die of the desired form.

Other types of unsaturated polyester-containing composite materials, such as glass-fiber reinforced composites, are conventionally cured at room temperature using a ketone peroxide (generally methyl ethyl ketone peroxide) and a metal accelerator, such as a cobalt salt. The curing reaction is initiated at room temperature by the joint action of peroxide and accelerator and can proceed by the heat that is produced during the exothermic curing reaction. These composite materials typically contain an amount of 60-70 wt % resin and 30-40 wt % glass reinforcement.

Agglomerated stone, on the other hand, contains significantly less resin, i.e. only about 5-25 wt %. This means that the amount of heat that is produced in the composite mixture during the reaction is insufficient for propagating a reaction that is initiated at room temperature. Agglomerated stone production thus requires external heating. The same holds for highly filled fiber-based systems.

The production of these highly filled systems furthermore requires a rather long potlife. Potlife is the time between mixing the resin with the cure system and the start of the curing reaction. Accelerated ketone peroxide-based systems do not provide a sufficiently long potlife.

These requirements therefore demand a peroxide that is activated at higher temperature than ketone peroxides. Peroxyesters are very suitable for this purpose.

Unfortunately, however, peroxyesters tend to cause a very high peak exotherm during the curing process. As a result, inner parts of the composite are exposed to very high temperatures during the curing reaction, which causes stress in the resulting article. This stress often results in deformation of the article and/or cracks. Therefore, there remains an opportunity for improvement.

### BRIEF SUMMARY

This disclosure provides a process for the production of a composite article, comprising the steps of:

a) providing a curable mixture comprising:
about 30-95 wt % of filler material,
about 5-70 wt % of resin, selected from unsaturated polyester resins, vinyl ester resins, (meth)acrylate resins, and combinations thereof,
about 0.5-10 phr of at least one peroxyester,
about 0.1-2.0 phr of at least one organic hydroperoxide,
the weight ratio peroxyester/organic hydroperoxide being below about 14.0, the curable mixture being essentially free of ketone peroxide,
b) shaping the mixture, and
c) heating the shaped mixture at a temperature in the range of about 60-100° C. to affect hardening of the resin and the formation of an article.

This disclosure also provides an organic peroxide formulation comprising:
about 50-80 wt % pf peroxyester,
about 1-20 wt % of organic hydroperoxide,
about 0-25 wt % of a promoter,
about 0-25 wt % of an organic solvent,
   the formulation being essentially free of ketone peroxide and comprises the peroxyester and the organic hydroperoxide in a weight ratio peroxyester/hydroperoxide of below 14.0.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or in the following detailed description.

It is therefore an object of the present disclosure to provide a process for the production of composite articles using a peroxyester, which process results in a relatively low peak exotherm and sufficient potlife.

It is a further desire that the curing time is acceptably short.

This object has been met by using a combination of a peroxyester and an organic hydroperoxide.

The present disclosure therefore relates to a process for the production of a composite article, comprising the steps of:
(a) providing a curable mixture comprising:
   30-95 wt % of filler material,
   about 5-70 wt % of resin, selected from unsaturated polyester resins, vinyl ester resins, (meth)acrylate resins, and combinations thereof,
   about 0.5-10 phr (=weight parts per hundred weight parts of resin) of at least one peroxyester,
   about 0.1-2.0 phr (=weight parts per hundred weight parts of resin) of at least one organic hydroperoxide,
   the weight ratio peroxyester/organic hydroperoxide being below 14.0, and said mixture being essentially free of ketone peroxide,
(b) shaping the mixture, and
(c) heating the shaped mixture at a temperature in the range about 60-100° C. to affect hardening of the resin and the formation of an article.

Suitable filler materials include stone particles and fibers.

Stone particles are particles obtained by crushing natural rock or ceramic materials. Examples of suitable materials are quartz, granite, marble, silica sand, porphyry, basalt, marble, dolomite, and colored stones. Quartz and marble are the most preferred materials. The particles preferably have a diameter of about 120 mm or less. The desired particle size depends on the application of the resulting article. Suitable particle size fractions are in the range about 2.5-120 mm, in the range about 0.063-2.5 mm, or below about 0.063 mm.

Curable mixtures comprising such particles, preferably contain them in an amount of about 75-95 wt %, more preferably about 80-95 wt %, even more preferably about 85-95 wt %, and most preferably about 90-95 wt %. The resin content in such curable mixtures is preferably about 5-25 wt %, more preferably about 5-20 wt %, even more preferably about 5-15 wt %, and most preferably about 5-10 wt %.

Examples of fibers are glass fibers, nylon fibers, polyester fibers, aramid fibers (e.g. Twaron®), carbon fibers, cellulose fibers (wood fiber, paper fiber, straw), and natural fibers (e.g. jute, kenaf, industrial hemp, flax (linen), ramie, bamboo, grass, reed, etc.). The most preferred fibers are glass fibers.

Curable mixtures comprising such fibers, preferably contain them in an amount of about 50-80 wt %, more preferably about 60-80 wt %, and most preferably about 65-75 wt %. The resin content in such curable mixtures is preferably about 20-50 wt %, more preferably about 20-40 wt %, and most preferably about 25-35 wt %.

In the context of the present application, the terms “unsaturated polyester resin” and “UP resin” refer to the combination of unsaturated polyester resin and ethylenically unsaturated monomeric compound. The term “vinyl ester resin” refers to a resin produced by the esterification of an epoxy resin with an unsaturated monocarboxylic acid, and dissolved in an ethylenically unsaturated monomeric compound. UP resins and vinyl ester resins as defined above are common practice and commercially available.

Suitable UP resins are so-called ortho-resins, iso-resins, iso-npg resins, and dicyclopentadiene (DCPD) resins.

Acrylate and methacrylate resins without an additional ethylenically unsaturated monomeric compound like styrene are referred to in this application as (meth)acrylate resins.

Examples of ethylenically unsaturated monomeric compounds are: styrene and styrene derivatives like α-methyl styrene, vinyl toluene, indene, divinyl benzene, vinyl pyrrolidone, vinyl siloxane, vinyl caprolactam, stilbene, but also diallyl phthalate, dibenzylidene acetone, allyl benzene, methyl methacrylate, methylacrylate, (meth)acrylic acid, diacrylates, dimethacrylates, acrylamides; vinyl acetate, triallyl cyanurate, triallyl isocyanurate, allyl compounds which are used for optical application (such as (di)ethylene glycol diallyl carbonate), chlorostyrene, tert-butyl styrene, tert-butylacrylate, butanediol dimethacrylate and mixtures thereof. Suitable examples of (meth)acrylates reactive diluents are PEG200 di(meth)acrylate, 1,4-butanediol di(meth)acrylate, 1,3-butanediol di(meth)acrylate, 2,3-butanedioldi(meth)acrylate, 1,6-hexanediol di(meth)acrylate and its isomers, diethyleneglycol di(meth)acrylate, triethyleneglycol di(meth)acrylate, glycerol di(meth)acrylate, trimethylolpropane di(meth)acrylate, neopentyl glycol di(meth)acrylate, dipropyleneglycol di(meth)acrylate, tripropyleneglycol di(meth)acrylate, PPG250 di(meth)acrylate, tricyclodecane dimethylol di(meth)acrylate, 1,10-decanediol di(meth)acrylate, tetraethylene glycol di(meth)acrylate, trimethylolpropanetri(meth)acrylate, glycidyl (meth)acrylate, (bis)maleimides, (bis)citraconimides, (bis)itaconimides, and mixtures thereof.

The conventional unsaturated monomer is styrene, which is the preferred monomer from an economical point of view.

The amount of ethylenically unsaturated monomer in UP and vinyl ester resin is preferably at least about 0.1 wt %, based on the total weight of the resin, more preferably at least about 1 wt %, and most preferably at least about 5 wt %. The amount of ethylenically unsaturated monomer is preferably not more than about 50 wt %, more preferably not more than about 40 wt %, and most preferably not more than about 35 wt %.

Examples of suitable peroxyesters to be used in the process of the present disclosure are tert-butyl peroxybenzoate, tert-butylperoxy-3,5,5-trimethylhexanoate, 1,1-di(tert-butylperoxy)-3,5,5-trimethylhexanoate, tert-butyl-peroxyacetate, tert-butyl-peroxypivalate, tert-butyl-peroxymaleate, 3-hydroxy-1,1-dimethyl-butyl-peroxy neoheptanoate, tert-butyl peroxy-2-ethylhexanoate, 2,5-dimethyl-2,5-di(2-ethylhexanoylperoxy)hexane, and combinations thereof.

More preferred are tert-butyl peroxybenzoate, tert-butylperoxy-3,5,5-trimethylhexanoate, tert-butyl peroxy-2-ethylhexanoate, and 2,5-dimethyl-2,5-di(2-ethylhexanoylperoxy)hexane.

Most preferred are tert-butyl peroxybenzoate and tert-butylperoxy-3,5,5-trimethylhexanoate.

The peroxyester is present in the curable mixture in an amount of 0.5-10 phr, preferably 1.0-5.0 phr, more preferably 1.0-3.0 phr.

Examples of suitable organic hydroperoxides are isopropyl cumyl hydroperoxide, pinane hydroperoxide, para-mentane hydroperoxide, cumyl hydroperoxide, 1,1,3,3-tetramethylbutyl hydroperoxide, tert-butyl hydroperoxide, tert-amyl hydroperoxide, and combinations thereof.

More preferred are isopropyl cumyl hydroperoxide, tert-amyl hydroperoxide, pinane hydroperoxide, and para-mentane hydroperoxide.

Most preferred is isopropyl cumyl hydroperoxide.

The organic hydroperoxide is present in the curable mixture in an amount of about 0.1-2 phr (=weight parts per hundred weight parts resin), preferably about 0.1-1.5 phr, more preferably about 0.2-1.0 phr.

The weight ratio peroxyester/hydroperoxide, calculated based on pure peroxide, in the curable mixture is below about 14.0, preferably below about 13.0, more preferably below about 12.0, even more preferably below about 11.0, even more preferably below about 10.0, and most preferably below about 8.0.

This weight ratio is preferably above about 1.0, more preferably above about 2.0, even more preferably above about 3.0. Most preferably, this weight ratio is in the range about 4.0-7.0.

The curable mixture is essentially free of ketone peroxide, which means that the mixture contains less than about 0.01 phr ketone peroxide, and most preferably is free of ketone peroxide. Ketone peroxides deteriorate the potlife of the mixture.

In a preferred embodiment, the curable mixture also contains a promoter.

The promoter is preferably a 1,3-diketone or an aromatic nitrogen-containing compound such as bipyridine and biquinoline.

Examples of 1,3-diketones are acetylacetone, benzoylacetone, and dibenzoyl methane, and acetoacetates such as diethyl acetoacetamide, dimethyl acetoacetamide, dipropyl acetoacetamide, dibutyl acetoacetamide, methyl acetoacetate, ethyl acetoacetate, propyl acetoacetate, and butyl acetoacetate. Preferred 1,3-diketones are acetylacetone (i.e. 2,4-pentanedione) and n,n-diethylacetoacetamide. Acetylacetone is the most preferred promoter.

The amount of promoter in the curable mixture is preferably in the range about 0.05-1 phr, most preferably about 0.1-0.5 phr.

The peroxyester and the organic hydroperoxide can be added to the resin individually, or as a blend. The peroxyester, the hydroperoxide, and the blend may be added as such, or dissolved or admixed with a solvent and/or promoter.

A suitable blend is the organic peroxide formulation according to the present disclosure, which comprises:
about 50-80 wt %, preferably about 60-80 wt %, and most preferably about 60-75 wt % peroxyester,
about 1-20 wt %, preferably about 5-20 wt %, and most preferably about 5-15 wt % organic hydroperoxide,
about 0-25 wt %, preferably about 1-25 wt %, and most preferably about 5-20 wt % promoter,
about 0-25 wt %, preferably about 1-20 wt %, and most preferably about 5-15 wt % organic solvent.

This formulation is essentially free of ketone peroxide, meaning that the formulation contains less than about 0.5 wt %, more preferably less than about 0.1 wt % ketone peroxide, and most preferably is free of ketone peroxide.

The weight ratio peroxyester/hydroperoxide in this formulation is below about 14.0, preferably below about 13.0, more preferably below about 12.0, even more preferably below about 11.0, even more preferably below about 10.0, and most preferably below 8.0.

This weight ratio is preferably above about 1.0, more preferably above about 2.0, even more preferably above about 3.0. Most preferably, this weight ratio is in the range about 4.0-7.0.

Suitable promoters are listed above. Most of these promoters may function both as promoter and as solvent.

Instead of or in addition to the promoter, the organic peroxide formulation may contain a further organic solvent. Hence, the term “organic solvent” refers to organic solvents other than promoters. Suitable organic solvents are aliphatic hydrocarbon solvents, aromatic hydrocarbon solvents, and solvents that carry an aldehyde, ketone, ether, ester, alcohol, phosphate, or carboxylic acid group. Examples of suitable organic solvents are aliphatic hydrocarbon solvents such as white spirit and odourless mineral spirit (OMS), aromatic hydrocarbon solvents such naphthenes and mixtures of naphthenes and paraffins, isobutanol, pentanol, methylethyl ketone oxime, 1,2-dioximes, N-methyl pyrrolidinone, N-ethyl pyrrolidinone, dimethyl formamide (DMF), dimethyl sulphoxide (DMSO), 2,2,4-trimethyl pentanediol diisobutyrate (TxIB), esters such as dibutyl maleate, dibutyl succinate, ethyl acetate, butyl acetate, mono- and diesters of ketoglutaric acid, pyruvates, and esters of ascorbic acid (such as ascorbic palmitate), aldehydes, mono- and diesters (more in particular diethyl malonate, dimethyl phthalate, and succinates), 1,2-diketones (in particular diacetyl and glyoxal), benzyl alcohol, and fatty alcohols.

A specifically desired type of organic solvent is a hydroxy-functional solvent, which includes compounds of the formula HO—(—CH₂—C(R¹)₂—(CH₂)ₘ—O—)ₙ—R², wherein each R¹ is independently selected from the group consisting of hydrogen, alkyl groups with about 1-10 carbon atoms, and hydroxyalkyl groups with about 1 to 10 carbon atoms, n=1-10, m=0 or 1, and R² is hydrogen or an alkyl group with about 1-10 carbon atoms. Most preferably, each R¹ is independently selected from H, CH₃, and CH₂OH. Examples of suitable hydroxy-functional solvents are glycols like diethylene monobutyl ether, ethylene glycol, diethylene glycol, dipropylene glycol, and polyethylene glycols, glycerol, and pentaerythritol.

In a preferred embodiment, the organic peroxide formulation comprises:
about 50-80 wt %, preferably about 60-80 wt %, and most preferably about 60-75 wt % peroxyester,
about 1-20 wt %, preferably about 5-20 wt %, and most preferably about 5-15 wt % organic hydroperoxide,
about 1-25 wt %, preferably about 1-20 wt % of an 1,3-diketone, and
about 1-15 wt %, preferably about 5-15 wt % of an organic solvent.

This formulation is essentially free of ketone peroxide, meaning that the formulation contains less than about 0.5 wt %, more preferably less than about 0.1 wt % ketone peroxide, and most preferably is free of ketone peroxide.

The weight ratio peroxyester/hydroperoxide in this formulation is below about 14.0, preferably below about 13.0, more preferably below about 12.0, even more preferably below about 11.0, even more preferably below about 10.0, and most preferably below about 8.0.

This weight ratio is preferably above about 1.0, more preferably above about 2.0, even more preferably above about 3.0. Most preferably, this weight ratio is in the range about 4.0-7.0.

Even more preferred, the organic peroxide formulation comprises:
about 60-75 wt % peroxyester, preferably selected from tert-butyl perbenzoate and tert-butyl-3,5,5-trimethylhexanoate,
about 5-15 wt % organic hydroperoxide, preferably selected from isopopyl cumyl hydroperoxide, tert-amyl hydroperoxide, pinane hydroperoxide, and paramethane hydroperoxide,
about 1-20 wt % of an 1,3-diketone, and
about 1-15 wt % of an organic solvent,
   wherein the formulation is free of ketone peroxide, the weight ratio peroxyester/hydroperoxide is in the range about 4.0-7.0.

The curable mixture formed in step (a) of the process preferably additionally contains a metal accelerator, preferably a Co salt or complex, such as cobalt octoate or cobalt naphthenate, a copper salt or complex, an iron salt or complex, and/or a manganese salt or complex. More preferably, the curable mixture formed in step (a) of the process contains an iron salt or complexes and/or a manganese salt or complex.

Examples of iron (II) and iron (III) salts and complexes are iron chloride, nitrate, sulphate, lactate, 2-ethyl hexanoate (octoate), octanoate, nonanoate, heptanoate, neodecanoate, naphthenate, acetate, and iron complexes of tridentate, tetradentate, pentadentate, or hexadentate nitrogen donor ligands disclosed in WO 2011/83309, more in particular the bispidon ligands and the TACN-Nx ligands. The preferred bispidon ligand is dimethyl-2,4-di-(2-pyridyl)-3-methyl-7-(pyridin-2-ylmethyl)-3,7-diaza-bicyclo[3.3.1]nonan-9-one-1,5-dicarboxylate (N2py3o-Cl). The preferred TACN-Nx ligand is 1,4,7-trimethyl-1,4,7-triazacyclononane (Me3-TACN).

Examples of manganese salts and complexes are manganese chloride, nitrate, sulphate, lactate, 2-ethyl hexanoate, octanoate, nonanoate, heptanoate, neodecanoate, naphthenate, and acetate, and the Mn complexes of pyridine, porphirine-based ligands, and of the tridentate, tetradentate, pentadentate, or hexadentate nitrogen donor ligands disclosed in WO 2011/83309, more in particular the bispidon ligands and the TACN-Nx ligands. The preferred bispidon ligand is dimethyl-2,4-di-(2-pyridyl)-3-methyl-7-(pyridin-2-ylmethyl)-3,7-diaza-bicyclo [3.3.1]-nonan-9-one-1,5-dicarboxylate (N2py3o-Cl). The preferred TACN-Nx ligand is 1,4,7-trimethyl-1,4,7-triazacyclononane (Me₃-TACN). Any one of Mn(II), Mn(III), Mn(IV), and Mn(VII) compounds can be used.

The mixture formed in step (a) of the process of the present disclosure may further contain additional materials, such as mineral fillers (e.g. micronized silica or feldspar), bifunctional silanes or titanates to improve the bonding between the resin and the fibers or stone particles, and/or coloring agents.

In addition, the mixture may contain one or more metal carboxylate salts of ammonium, alkali metals, and alkaline earth metals are the 2-ethyl hexanoates (i.e. octanoates), nonanoates, heptanoates, neodecanoates, and naphthenates. The preferred alkali metal is K. the most preferred metal carboxylate salt is potassium octanoate. These salts are often already incorporated in the resin.

In step (a) of the process according to the present disclosure, the ingredients are mixed before being shaped and heated.

Optionally, the resin and/or the filler material are pre-heated to a temperature of about 20-35° C., more preferably about 25-30° C., before they are mixed with the other components.

In a preferred embodiment, the peroxyester, the organic hydroperoxide, and the optional promoter are first mixed with the resin before they are mixed with the filler material.

The mixture is subsequently shaped in a desired form.

Shaping can be performed by placing the mixture in a mould or on a temporary support, after which is preferably compacted. Compacting can be performed by vacuum vibrocompression, i.e. vacuum compression with the simultaneous application of a vibratory motion as described in, for instance, EP 0 786 325. After the heating step, the cured article can be removed from the mould or temporary support. This form of shaping is preferred for mixtures comprising stone particles.

Another form of shaping is pulling the mixture through a heated die, for instance by a pultrusion technique. This is the preferred way of shaping fiber-containing mixtures.

During or after shaping, the curable mixture is heated to allow the curing of the resin to occur. Heating is preferably conducted in an environment with a controlled temperature of about 60-100° C., and preferably about 80-90° C. The article can then be further cooled to ambient temperature (about 20-30° C.). This step is preferably performed without subjecting the article to any thermal shocks or cold air flows.

The resulting article can be used for various applications, such as the production of kitchen worktops, flooring materials, window profiles, facade panels, reinforcement bars, construction materials, rails, and grips.

### EXAMPLES

### Comparative Example 1

To 100 grams UP resin (Palatal® P4), 0.2 grams of a cobalt(II) octanoate accelerator (Accelerator NL-51P, ex-AkzoNobel) were added. Thereafter, 2 grams of a 90 wt % solution of tert-butylperoxy-3,5,5-trimethylhexanoate in acetylacetone (Trigonox® 42PR, ex-AkzoNobel) were added and mixed. Subsequently, 200 grams of quartz filler were added.

The resulting mixture was poured into a test tube containing a thermocouple. The test tube was heated in a water bath of 80° C. The temperature of the mixture was recorded in time. Geltime (GT; the time required for the mixture temperature to increase from 63.3° C. to 85.6° C.), time to peak (TTP; the time required to reach the maximum temperature), peak exotherm (PE; maximum temperature reached), and minimum cure time (MCT; the time lapsed starting from 63.3° C. till the maximum temperature) were determined. The results are displayed in Table 1.

### Example 2

Comparative Example 1 was repeated, but with the additional presence of 0.5 grams of a 55 wt % solution of isopropylcumyl hydroperoxide in diisopropylbenzene (Trigonox® M-55, ex-AkzoNobel).

### Example 3

Example 2 was repeated, except that the peroxyester solution and the hydroperoxide solution were pre-mixed prior to their addition to the resin mixture.

### Example 4

Example 2 was repeated, except that different amounts of peroxyester and hydroperoxide were used.

### Comparative Example 5

Comparative Example 1 was repeated, using 2 grams of an 80% tert-butylperoxybenzoate solution in acetylacetone (Trigonox® 93, ex-AkzoNobel) instead of 2 grams Trigonox® 42PR.

### Example 6

Comparative Example 5 was repeated, but with the additional presence of 0.5 grams of a 55 wt % solution of isopropylcumyl hydroperoxide in diisopropylbenzene (Trigonox® M-55, ex-AkzoNobel).

### Example 7

Comparative Example 5 was repeated, but with the additional presence of 0.5 grams of a 90 wt % solution of cumyl hydroperoxide in an aromatic solvent mixture (Trigonox® K-90, ex-AkzoNobel).

### Example 8

Comparative Example 5 was repeated, but with the additional presence of 0.5 grams of a 85 wt % solution of tert-amyl hydroperoxide in water (Trigonox® TAHP-W85, ex-AkzoNobel).

### Example 9

Comparative Example 5 was repeated, but with the additional presence of 0.5 grams of a 50-55 wt % solution of pinane hydroperoxide in a mixture of ci-pinane, trans-pinane and cis-pinanol (Glidox® 500, ex-Symrise).

TABLE 1

| | weight ratio | GT | MCT | TTP | PE |
|---|---|---|---|---|---|
| Example | peroxyester/hydroperoxide | (min) | (min) | (min) | (° C.) |
| Comp. 1 | 1.8/0 | 1.5 | 3.3 | 5.1 | 123 |
| 2 | 1.8/0.28 = 6.4 | 1.6 | 4.4 | 6.1 | 109 |
| 3 | 1.8/0.28 = 6.4 | 1.6 | 4.3 | 6.3 | 113 |
| 4 | 1.35/0.55 = 2.5 | 2.5 | 6.5 | 8.5 | 99 |
| | 0.9/0.82 = 1.1 | 3.7 | 6.3 | 8.1 | 88 |
| | 2.0/0.14 = 14.3 | 1.6 | 3.7 | 5.6 | 121 |
| | 1.8/0.14= 12.9 | 1.8 | 4.1 | 6.0 | 119 |
| | 1.8/0.55 = 3.3 | 1.7 | 4.9 | 6.7 | 102 |
| | 1.35/0.28 = 4.8 | 2.2 | 5.5 | 7.6 | 111 |
| | 2.25/0.28 = 8.0 | 1.7 | 4.0 | 5.8 | 113 |
| Comp. 5 | 1.6/0 | 2.2 | 4.7 | 6.5 | 123 |
| 6 | 1.6/0.28 = 5.7 | 2.1 | 5.4 | 7.0 | 113 |
| 7 | 1.8/0.45 = 4.0 | 2.1 | 6.0 | 8.0 | 103 |
| 8 | 1.8/0.42 = 4.3 | 3.0 | 5.5 | 7.5 | 89 |
| 9 | 1.8/0.25 = 7.2 | 1.7 | 5.0 | 7.0 | 100 |

### Example 10

The potlife of was determined of three curable mixtures:

the mixture of Comparative Example 1,

the mixture of Example 3, and

the mixture of Example 3 additionally containing 5 wt % Butanox® M50 (methyl ethyl ketone peroxide solution in dimethyl phthalate; active oxygen content 8.8-9.0 wt %; ex-AkzoNobel).

The potlife was determined by visually checking the point of gelation of the unfilled resin system at 40° C. in an oil bath.

The mixtures of Comparative Example 1 and Example 3 both had a potlife of 75-80 min. The methyl ethyl ketone peroxide-containing mixture had a potlife of only 17 min.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. Process for the production of a composite article, comprising the steps of:
a) providing a curable mixture comprising:
about 30-95 wt % of filler material,
about 5-70 wt % of resin, selected from unsaturated polyester resins, vinyl ester resins, (meth)acrylate resins, and combinations thereof,
about 0.5-10 phr of at least one peroxyester,
about 0.1-2.0 phr of at least one organic hydroperoxide,
the weight ratio peroxyester/organic hydroperoxide being below about 14.0,
the curable mixture being essentially free of ketone peroxide,
b) shaping the mixture, and
c) heating the shaped mixture at a temperature in the range of about 60-100° C. to affect hardening of the resin and the formation of an article.

2. Process according to claim 1 wherein the filler material comprises stone particles.

3. Process according to claim 2 wherein the mixture comprises about 85-95 wt % stone particles.

4. Process according to claim 1 wherein the filler material comprises reinforcing fibers.

5. Process according to claim 4 wherein the mixture comprises about 50-80 wt % reinforcing fibres.

6. Process according to claim 1 wherein the peroxyester is chosen from tert-butyl peroxybenzoate, tert-butylperoxy-3,5,5-trimethylhexanoate, 1,1-di(tert-butylperoxy)-3,5,5-trimethylhexanoate, tert-butyl-peroxyacetate, tert-butyl-peroxypivalate, tert-butyl-peroxymaleate, 3-hydroxy-1,1-dimethyl-butyl-peroxy neoheptanoate, tert-butyl peroxy-2-ethylhexanoate, 2,5-dimethyl-2,5-di(2-ethylhexanoylperoxy)hexane, and combinations thereof.

7. Process according to claim 1 wherein the organic hydroperoxide is selected from isopropyl cumyl hydroperoxide, pinane hydroperoxide, para-mentane hydroperoxide, cumyl hydroperoxide, 1,1,3,3-tetramethylbutyl hydroperoxide, tert-butyl hydroperoxide, tert-amyl hydroperoxide, and combinations thereof.

8. Process according to claim 1 wherein the weight ratio peroxyester/hydroperoxide is below about 13.0.

9. Process according to claim 1 wherein the mixture additionally comprises a cure accelerator selected from Co, Cu, Mn, and Fe salts and complexes.

10. Process according to claim 1 wherein the mixture additionally comprises a 1,3-diketone.

11. Organic peroxide formulation comprising:
about 50-80 wt % peroxyester,
about 1-20 wt % organic hydroperoxide,
about 0-25 wt % a promoter,
about 0-25 wt % an organic solvent,
said formulation being essentially free of ketone peroxide and comprises the peroxyester and the organic hydroperoxide in a weight ratio peroxyester/hydroperoxide of below about 14.0.

12. Organic peroxide formulation according to claim 11 wherein the peroxyester is chosen from tert-butyl peroxybenzoate, tert-butylperoxy-3,5,5-trimethylhexanoate, 1,1-di(tert-butylperoxy)-3,5,5-trimethylhexanoate, tert-butyl-peroxyacetate, tert-butyl-peroxypivalate, tert-butyl-peroxymaleate, 3-hydroxy-1, 1-dimethyl-butyl-peroxy neoheptanoate, and combinations thereof.

13. Organic peroxide formulation according to claim 11 wherein the hydroperoxide is selected from isopropyl cumyl hydroperoxide, pinane hydroperoxide, para-mentane hydroperoxide, cumyl hydroperoxide, 1,1,3,3-tetramethylbutyl hydroperoxide, tert-butyl hydroperoxide, tert-amyl hydroperoxide, and combinations thereof.

14. Organic peroxide formulation according to claim 11, comprising:
about 60-75 wt % of a peroxyester,
about 5-15 wt % of an organic hydroperoxide,
about 1-20 wt % of a 1,3-diketone, and
about 1-15 wt % of an organic solvent,
wherein the formulation is free of ketone peroxide, the weight ratio peroxyester/hydroperoxide is in the range of about 4.0-7.0.

15. Organic peroxide formulation according to claim 11 wherein the promoter is an 1,3-diketone.

16. The process of claim 1 herein the peroxyester is chosen from from tert-butyl peroxybenzoate and tert-butylperoxy-3,5,5-trimethylhexanoate.

17. The process of claim 16 wherein the organic hydroperoxide is chosen from isopropyl cumyl hydroperoxide, pinane hydroperoxide, para-mentane hydroperoxide, cumyl hydroperoxide, 1,1,3,3-tetramethylbutyl hydroperoxide, tert-butyl hydroperoxide, tert-amyl hydroperoxide, and combinations thereof, preferably selected from isopropyl cumyl hydroperoxide, pinane hydroperoxide, and para-mentane hydroperoxide.

18. The process of claim 17 wherein the weight ratio peroxyester/hydroperoxide is from about 4.0 to about 7.0.

19. The process of claim 18 wherein the mixture additionally comprises a cure accelerator selected from Co, Cu, Mn, and Fe salts and complexes.

20. The process of claim 19 wherein the mixture additionally comprises a 1,3-diketone, chosen from acetylacetone and n,n-diethylacetoacetamide.
